(19) United States
(12) Patent Application Publication
(10) Pub. No.: US 2017/0185567 A1
(43) Pub. Date: Jun. 29, 2017

(54) USER INTERFACE CONTROL LAYOUT METHOD AND ELECTRONIC DEVICE

(71) Applicants: Le Holdings (Beijing) Co., Ltd., Beijing (CN); Le Shi Zhi Xin Electronic Technology (Tianjin) Limited, Binhal New Area (CN)

(72) Inventor: Shen Li, Binhai New Area (CN)

(21) Appl. No.: 15/242,890

(22) Filed: Aug. 22, 2016

Related U.S. Application Data
(63) Continuation of application No. PCT/CN2016/089570, filed on Jul. 10, 2016.

(30) Foreign Application Priority Data
Dec. 28, 2015 (CN) 201511019991.9

(51) Int. Cl. G06F 17/21

(52) U.S. Cl. CPC G06F 17/212

(57) ABSTRACT

Embodiments of this disclosure relate to the field of multimedia technologies, and disclose a user interface control layout method and an electronic devices. The user interface control layout method includes the following steps: creating a relative layout container, where the relative layout container is used to contain child controls, and the child controls are a relative layout container or a normal control; specifying an attribute of a child control for the relative layout container; generating the child control; and if the child control is a relative layout container, repeating the foregoing steps, until all the child controls in the relative layout container are normal controls. In some embodiments of this disclosure, multiple UI controls of different sizes or types may be generated one by one through layout and arrangement, and the UI controls of different sizes or types may be nested with each other, and thereby UI interfaces based on different rules can be quickly implemented to meet different requirements of various products for UI control arrangement.

### CROSS-REFERENCE TO RELATED APPLICATIONS

The present disclosure is a continuation of PCT application No. PCT/CN2016/089570 submitted on Jul. 10, 2016, and claims priority to Chinese Patent Application No. 201511019991.9, filed with the Chinese Patent Office on Dec. 28, 2015 and entitled “USER INTERFACE CONTROL LAYOUT METHOD AND SYSTEM, AND USER INTERFACE CONTROL CONTROLLING METHOD AND SYSTEM”, which is incorporated herein by reference in its entirety.

### TECHNICAL FIELD

Embodiments of this disclosure relate to the field of multimedia technologies, and in particular, to a user interface control layout method and an electronic device.

### BACKGROUND

With continuous development of science and technologies and unceasing progress of multimedia technologies, application software for playing videos has increasingly great varieties and increasingly strong capabilities. A user can install a video application in a mobile terminal, and thereafter watch a video by using the video application. With improvement of the Internet infrastructure, increasing of a network speed, and decreasing of costs of accessing the Internet, a increasingly large quantity of users watch videos on the Internet by using mobile terminals. The video application can play numerous videos for the user, for example, the user can watch live broadcasts, matches, TV programs, and the like by using the video application.

In a process of implementing the present disclosure, the inventor discovers that various 3D controls, for example, application icons corresponding to applications already installed on a video playing device, are displayed in a video playing interface. Taking a common video playing device in people's life, a smart television, for example, for a current smart television, often only a selection operation can be performed on controls in an interface by using a remote control device, for example, an application icon is selected by using the remote control device to enter an application needed by the user. However, in an actual application, the user may need to perform various operations, for example, 3D control movement, 3D control management, and comment viewing, on 3D controls in the interface. Moreover, currently, numerous 3D UI controls (UI is the abbreviation of User Interface) related to video information exist in a virtual reality application based on mobile phones. Currently, a 3D control in a virtual reality VR (VR is the abbreviation of Virtual Reality) application is generally created according to a need of a UI interface for a particular scenario, and each 3D control is individually created in a UI menu for the scenario. However, current methods for creating a 3D control in a virtual reality VR application based on mobile phones are relatively inflexible and complex.

### SUMMARY

This disclosure provides a user interface control layout method and an electronic device, so that multiple UI controls of different sizes or types may be generated one by one through layout and arrangement, and the UI controls of different sizes or types may be nested with each other, and thereby UI interfaces based on different rules can be quickly implemented to meet different requirements of various products for UI control arrangement.

According to a first aspect, an embodiment of this disclosure provides a user interface control layout method, applied to an electronic device, including the following steps: creating a relative layout container, where the relative layout container is used to contain child controls, and the child controls are a relative layout container or a normal control; specifying an attribute of a child control for the relative layout container; generating the child control; and if the child control is a relative layout container, repeating the foregoing steps, until all the child controls in the relative layout container are normal controls.

According to a second aspect, an embodiment of this disclosure provides a non-volatile computer storage medium, which includes a computer executable instruction, where when executed by at least one processor, the computer executable instruction causes the processor to execute the foregoing user interface control layout method.

According to a third aspect, an embodiment of this disclosure further provides an electronic device, including: at least one processor; and a memory communicably connected with the at least one processor for storing instructions executable by the at least one processor, where execution of the instructions by the at least one processor causes the at least one processor to execute any foregoing user interface control layout method of this disclosure.

According to the user interface control layout method and the electronic device provided in the embodiments of this disclosure, a relative layout container is created, multiple child controls of different sizes or types are contained in the created relative layout container, and the child controls of different sizes or types may be generated one by one through layout and arrangement, which greatly simplifies a complex process of creating 3D controls of irregular sizes in a scenario. An attribute of a child control is specified for the relative layout container, and the child control is generated, so that a child control is generated in a relatively simple manner, controlling and modification of a child control are facilitated, and errors during repeated development of user interface controls are avoided. In addition, if the child control is a relative layout container, an attribute of a child control is continued to be specified for the relative layout container and the child control is generated, until all the child controls in the relative layout container are normal controls. Therefore, the child controls of different sizes or types may be nested with each other, and thereby UI interfaces based on different rules can be quickly implemented to meet different requirements of various products for child control arrangement.

In an embodiment, the step of specifying an attribute of a child control for the relative layout container includes the following sub-steps: specifying a type of the child control for the relative layout container, and automatically numbering the child control; specifying a position reference control for the child control; setting a position offset of the child control relative to the reference control and a size of the child control. By means of the foregoing method, a child control is controlled or modified by using a number corresponding to the child control, so that controlling or modification of each child control is relatively simple, accurate, and less error-prone. By arranging child controls in this manner, a complex process of creating different regular child controls in a scenario can be simplified, controlling and modification of an entire UI interface and a single child control of the UI interface in the scenario are facilitated, and reusability of a graphic engine for developing a virtual reality application is greatly improved.

In an embodiment, in the step of specifying a position reference control for the child control, if the child control is a first child control in the relative layout container, the relative layout container is specified as the reference control; and in the step of setting a position offset of the child control relative to the reference control, the position offset is a first preset offset distance relative to a position of the reference control. By arranging child controls in this manner, an arrangement manner of the child controls is more simple and easy to implement, and is convenient for modification and secondary development by developers, which can improve efficiency of child control creation.

In an embodiment, in the step of specifying a position reference control for the child control, if the child control is not a first child control in the relative layout container, another child control in a same relative layout container is specified as the child control as the reference control; and in the step of setting a position offset of the child control relative to the reference control, the position offset is a second preset offset distance relative to each edge of the reference control that is relatively close to the child control. By arranging child controls in this manner, an arrangement manner of the child controls is more simple and easy to implement, and is convenient for modification and secondary development by developers, which can improve efficiency of child control creation.

In an embodiment, after the step of creating a relative layout container, and before the step of specifying an attribute of a child control for the relative layout container, the method further includes the following steps: creating a menu object in a scenario; and binding the menu object to the relative layout container, and setting a position of the relative layout container in the scenario. Therefore, different scenarios can be corresponding to different menu objects, and correspondences therebetween are simple and less error-prone, so that a position relationship of a relative layout container is relatively clear.

In an embodiment, in the step of acquiring a preset operation event, the relative layout container acquires the preset operation event, and transfers the preset operation event to the child control; or the child control acquires the preset operation event, and transfers the preset operation event to the relative layout container; or both the relative layout container and the child control acquire the preset operation event, and transfer the preset operation event to each other. The preset operation event may be acquired in any of the manners according to needs of developers, so that a manner of acquiring a preset operation event is relatively diversified, and thereby requirements of different designers can be satisfied.

### BRIEF DESCRIPTION OF THE DRAWINGS

One or more embodiments are exemplarily described by using figures that are corresponding thereto in the accompanying drawings; the exemplary descriptions do not form a limitation to the embodiments. Elements with same reference signs in the accompanying drawings are similar elements. Unless otherwise particularly stated, the figures in the accompanying drawings do not form a scale limitation.

FIG. 1 is a flowchart of a user interface control layout method according to Embodiment 1 of this disclosure;

FIG. 2 is a schematic diagram of a position when a child control is a first child control in a relative layout container in which the child control exists according to Embodiment 1 of this disclosure;

FIG. 3 is a schematic diagram of a position when a child control is not a first child control in a relative layout container in which the child control exists according to Embodiment 1 of this disclosure;

FIG. 4 is a block diagram of a user interface control layout system according to Embodiment 2 of this disclosure;

FIG. 5 is a schematic structural diagram of an electronic device according to Embodiment 7 of this disclosure; and

FIG. 6 is a schematic structural diagram of an electronic device according to Embodiment 8 of this disclosure.

### DETAILED DESCRIPTION

To make objectives, technical solutions, and advantages of this disclosure clearer, the technical solutions of this disclosure are clearly and completely described in detail below by using implementation manners with reference to figures in the accompanying drawings. Clearly, the described embodiments are some embodiments, rather than all embodiments, of this disclosure.

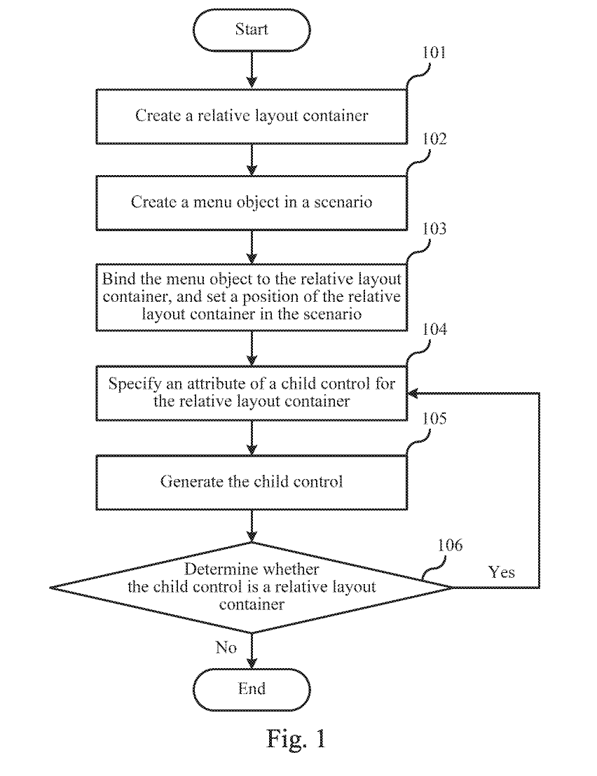

Embodiment 1 of this disclosure relates to a user interface control layout method. A specific flowchart is shown in FIG. 1, and includes the following steps.

Step 101: Create a relative layout container.

Specifically, a Relative Container class may be created as the relative layout container for containing different UI (UI is the abbreviation of User Interface) child controls of different types and different sizes, and the contained child controls may be a relative layout container or a normal control.

It is to be noted that, the child controls contained in the relative layout container are multiple user interface controls of different types and/or sizes, where the normal control includes any one of the following: a regular layout container, a button control, a text control, or a picture control.

Step 102: Create a menu object in a scenario. A menu object is created in a scenario according to a need of a UI interface for the particular scenario.

Step 103: Bind the menu object to the relative layout container, and set a position of the relative layout container in the scenario. The position of the relative layout container in the scenario may be set in any position in the UI scenario according to a need of actual designing, and is not limited in this implementation manner.

Step 104: Specify an attribute of a child control for the relative layout container. The attribute of the child control includes, but is not limited to, a type, a reference position, a position offset, and a size.

First, a type of the child control may be specified for the relative layout container, and the child control is automatically numbered.

For controlling and modification of each child control, the controlling or modification may be performed by using the relative layout container to obtain a number of the child control, which can enhance management of the UI menu, and levels of child controls are clearly hierarchical.

Then, a reference position and a position offset are specified for the child control. Specifically, a reference control is set by determining whether the child control is a first child control in the relative layout container, and a position of the reference control is used as the reference position.

If the child control is a first child control in the relative layout container, the relative layout container is specified as the reference control, and the position offset is set to a first preset offset distance relative to the position of the reference control.

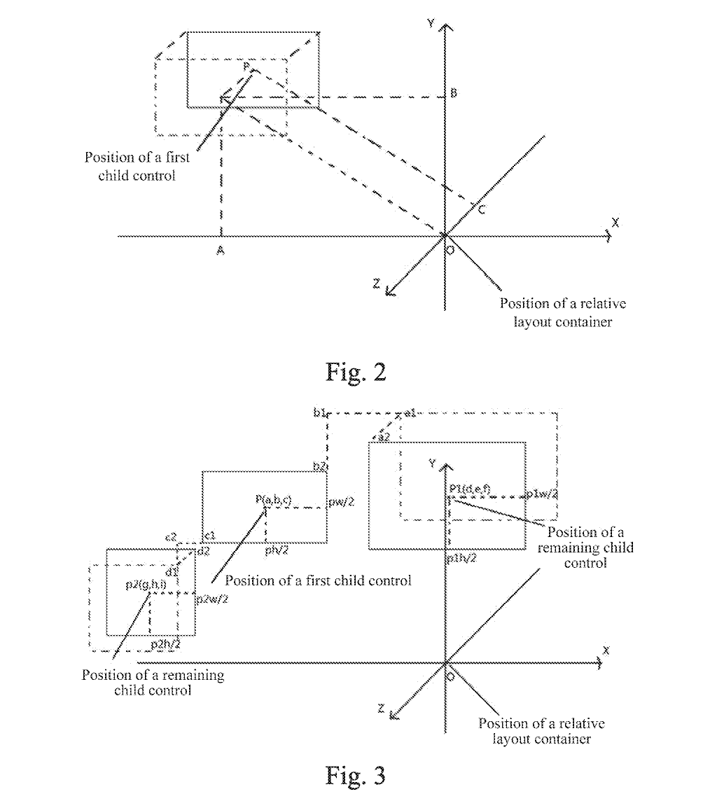

Specifically, a father object of the child control (that is, a relative layout container in which the child control exists) is used as a reference for the position offset of the child control. As shown in FIG. 2, assuming the position of the relative layout container is O, the position O of the relative layout container is specified as a position of a reference control, and the position offset is represented as offset (OA, OB, OC), then a position of a first child control is P (OA, OB, OC). The position offset is a preset value, which represents a first preset offset distance of the child control relative to the position of the reference control. The first preset distance may be set according to an actual layout requirement of the control.

If the child control is not a first child control in the relative layout container, another child control in a same relative layout container as the child control is specified as the reference control, and the position offset is set to a second preset offset distance relative to each edge of the reference control that is relatively close to the child control. The position offset of the child control herein is based on a position of an edge of the position reference control of the child control. The second preset distance may be set according to an actual layout requirement of the control.

Specifically, as shown in FIG. 3, if a position of a first child control is P (a, b, c), a position of a second child control is P1 (d, e, f), and a position of a third child control is P2 (g, h, i), then the position of the first child control is used as a reference for the second child control, and the position of the first child control or the second child control may be used as a reference for the third child control.

It is assumed that a second preset distance set for the first child control is (b1a1, b2b1, a1a2), that is, an offset of the position of the second child control relative to the position of the first child control is (b1a1, b2b1, a1a2). b1a1 represents an offset distance relative to a right edge (X direction in FIG. 3) of the first child control, b2b1 represents an offset distance relative to an upper edge (Y direction in FIG. 3) of the first child control, and a1a2 represents an offset distance relative to an outer edge (Z direction in FIG. 3) of the first child control. Then the position P1 of the second child control may be represented as:

P1(d, e, f)=P(a, b, c)+sizep(pw/2,ph/2,0)+offset (b1a1,b2b1,a1a2)+sizep1(p1w/2, p1h/2,0).

In the formula, pw, ph, p1w, and p1h represent sizes of the first child control and the second child control respectively.

Assuming the first child control is set to be a reference control for the third child control, and a second preset distance is (−c2c1, −d1c2, −d2d1), which represents distances relative to a left edge, a lower edge, and an inner edge of the first child control, then the position P2 of the third child control may be represented as:

P2(g, h, i)=P(a, b, c)−sizep(pw/2,ph/2,0)+offset (−c2c1,−d1c2,−d2d1)−sizep2(p2w/2, p2h/2,0).

In the formula, p2w and p2h represent sizes of the third child control respectively.

Finally, a size of the child control is set, for example, the size of the child control may be a two-dimensional vector representing width and height of the child control.

After completing the attribute setting of the child control, proceed to 105: Generate the child control.

Step 106: Determine whether the child control is a relative layout container. If the child control is a relative layout container, return to step 104, until all the child controls in the relative layout container are normal controls. So far, creation of the UI interface ends.

In this implementation manner, a relative layout container is created, multiple child controls of different sizes or types are contained in the created relative layout container, and the child controls of different sizes or types may be generated one by one through layout and arrangement. An attribute of a child control is specified for the relative layout container, and the child control is generated, so that a child control is generated in a relatively simple manner, controlling and modification of a child control are facilitated, and errors during repeated development of user interface controls are avoided. In addition, if the child control is a relative layout container, an attribute of a child control is continued to be specified for the relative layout container and the child control is generated, until all the child controls in the relative layout container are normal controls. Therefore, the child controls of different sizes or types may be nested with each other, and thereby UI interfaces based on different rules can be quickly implemented to meet different requirements of various products for child control arrangement.

In addition, it is worth noting that, in an actual application based on virtual reality, there exists a virtual reality 3D graphic engine for development of graphic functions of the application. Therefore, by adding a relative layout container class to the graphic engine, implementing functions, basic 3D UI controls, and an interface for a video database of the application, and thereby implementing fast layout of an irregular UI interface, a complex process of creating 3D controls of irregular sizes in a scenario is greatly simplified.

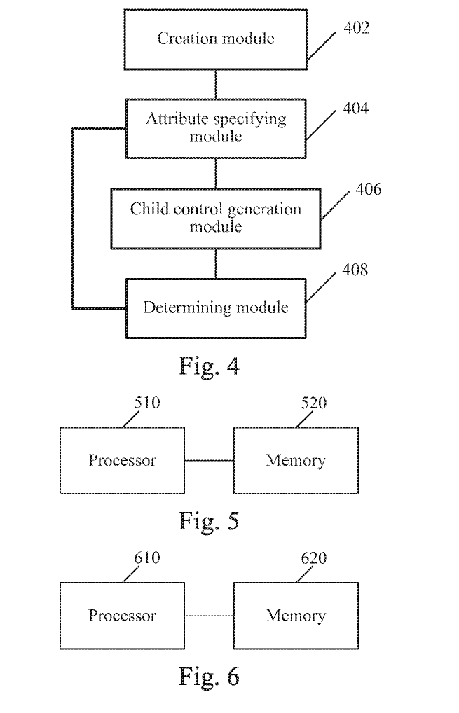

Embodiment 2 of this disclosure relates to a user interface control layout system. As shown in FIG. 4, the system includes a creation module 402, an attribute specifying module 404, a child control generation module 406, and a determining module 408.

The creation module 402 is configured to create a relative layout container, where the relative layout container is used to contain child controls, and the child controls are a relative layout container or a normal control. The attribute specifying module 404 is configured to specify an attribute of a child control for the relative layout container. The child control generation module 406 is configured to generate the child control. The determining module 408 is configured to: determine whether the child control is a relative layout container, and if the child control is a relative layout container, trigger the creation module, the attribute specifying module, and the child control generation module to repeat the generating a relative layout container and a child control of the relative layout container, until all the child controls in the relative layout container are normal controls.

It is not difficult to find that, this implementation manner is a system embodiment corresponding to the first implementation manner, and this implementation manner may be implemented in combination with the first implementation manner. —The related technical details mentioned in the first implementation manner still apply in this implementation manner, and are not described herein again for reducing repetitions. Correspondingly, the related technical details mentioned in this implementation manner can also be applied to the first implementation manner.

It is worth noting that, the modules revolved in this implementation manner are all logical modules. In actual applications, a logical unit may be a physical unit, or may be a part of a physical unit, or may be a combination of multiple physical units. In addition, to highlight creative parts of the present disclosure, units that are not closely related to the technical problems proposed in the present disclosure are not introduced in this implementation manner, but this does not indicate that other units do not exist in this implementation manner.

Embodiment 3 of this disclosure relates to a user interface control controlling method, including the following steps: acquiring a preset operation event; and modifying, according to the acquired preset operation, a unique attribute of a child control responding to the preset operation in a relative layout container; where the user interface controls are arranged by using the user interface control layout method described in the first implementation manner.

It is worth noting that, in the step of acquiring a preset operation event, the relative layout container may acquire the preset operation event, and transfer the preset operation event to the child control. Alternatively, the child control may acquire the preset operation event, and transfer the preset operation event to the relative layout container. Alternatively, both the relative layout container and the child control may acquire the preset operation event, and transfer the preset operation event to each other. In this way, a manner of acquiring a preset operation event is relatively diversified, and thereby requirements of different designers can be satisfied.

In this implementation manner, a preset operation event is acquired, and a unique attribute of a child control responding to the preset operation in a compound control is modified according to the acquired preset operation, so that modification and controlling of a unique attribute of each child control is relatively simple, and is less error-prone in an actual development or operation process.

Embodiment 4 of this disclosure relates to a user interface control controlling system, where the system includes a listening module and a modification module; where the listening module is configured to acquire a preset operation event; and the modification module is configured to modify, according to the acquired preset operation, a unique attribute of a child control responding to the preset operation in a relative layout container; where the user interface controls are arranged by using the user interface control layout system described in the second implementation manner.

It is not difficult to find that, this embodiment is a system embodiment corresponding to the third embodiment, and this embodiment may be implemented in combination with the third embodiment. The related technical details mentioned in the third embodiment still apply in this embodiment, and are not described herein again for reducing repetitions. Correspondingly, the related technical details mentioned in this embodiment can also be applied to the third embodiment.

It is worth noting that, the modules revolved in this implementation manner are all logical modules. In actual applications, a logical unit may be a physical unit, or may be a part of a physical unit, or may be a combination of multiple physical units. In addition, to highlight creative parts of the present disclosure, units that are not closely related to the technical problems proposed in the present disclosure are not introduced in this implementation manner, but this does not indicate that other units do not exist in this implementation manner.

The steps of the methods or algorithms described in combination with the disclosed embodiments in this specification may be embodied in hardware, software modules executed by a processor, or a combination thereof. The software modules may be resident in a random access memory (RAM), a flash memory, a read only memory (ROM), a programmable read only memory (PROM), an erasable read only memory (EROM), an erasable programmable read only memory (EPROM), an electrically erasable programmable read only memory (EEPROM), a register, a hard drive, a removable disk, a compact disc read only memory (CD-ROM), or any storage medium of another form known in the prior art. In an alternative scheme, storage media may be integrated with a processor. The processor and the storage media may be resident in an application-specific integrated circuit (ASIC). The ASIC may be resident in a computing apparatus or a user terminal, or the processor and the storage media may be resident in a computing apparatus or a user terminal as discrete components.

Embodiment 5 of this disclosure provides a non-volatile computer storage medium, which stores a computer executable instruction, where the computer executable instruction can execute the user interface control layout method in any foregoing method embodiment.

Embodiment 6 of this disclosure provides a non-volatile computer storage medium, which stores a computer executable instruction, where the computer executable instruction can execute the user interface control controlling method in any foregoing method embodiment.

FIG. 5 is a schematic structural diagram of hardware of an electronic device for executing a user interface control layout method provided in Embodiment 7 of this apparatus. As shown in FIG. 5, the electronic device includes:

one or more processors 510 and a memory 520, where only one processor 510 is used as an example in FIG. 5.

The processor 510 and the memory 520 may be connected by means of a bus or in other manners. A connection by means of a bus is used as an example in FIG. 5.

As a non-volatile computer readable storage medium, the memory 520 can be used to store non-volatile software programs, non-volatile computer executable programs and modules, for example, a program instruction/module (for example, the creation module 402, the attribute specifying module 404, the child control generation module 406, and the determining module 408 shown in FIG. 4) corresponding to the user interface control layout method in the embodiments of this disclosure. The processor 510 executes various functional applications and data processing of the server, that is, implements the user interface control layout method of the foregoing method embodiments, by running the non-volatile software programs, instructions, and modules that are stored in the memory 520.

The memory 520 may include a program storage area and a data storage area, where the program storage area may store an operating system and an application that is needed by at least one function; the data storage area may store data created according to use of the user interface control layout method, and the like. In addition, the memory 520 may include a high-speed random access memory, or may also include a non-volatile memory such as at least one disk storage device, flash storage device, or another non-volatile solid-state storage device. In some embodiments, the memory 520 optionally includes memories that are remotely disposed with respect to the processor 510, and the remote memories may be connected, via a network, to the user interface control layout system. Examples of the foregoing network include but are not limited to: the Internet, an intranet, a local area network, a mobile communications network, or a combination thereof.

The one or more modules are stored in the memory 520; when the one or more modules are executed by the one or more processors 510, the user interface control layout method in any one of the foregoing method embodiments is executed.

FIG. 6 is a schematic structural diagram of hardware of an electronic device for executing a user interface control layout method provided in Embodiment 8 of this apparatus. As shown in FIG. 6, the electronic device includes:

one or more processors 610 and a memory 620, where only one processor 610 is used as an example in FIG. 6.

The processor 610 and the memory 620 may be connected by means of a bus or in other manners. A connection by means of a bus is used as an example in FIG. 6.

As a non-volatile computer readable storage medium, the memory 620 can be used to store non-volatile software programs, non-volatile computer executable programs and modules, for example, a program instruction/module corresponding to the user interface control controlling method in the embodiments of this disclosure. The processor 610 executes various functional applications and data processing of the server, that is, implements the user interface control controlling method of the foregoing method embodiments, by running the non-volatile software programs, instructions, and modules that are stored in the memory 620.

The memory 620 may include a program storage area and a data storage area, where the program storage area may store an operating system and an application that is needed by at least one function; the data storage area may store data created according to use of the user interface control controlling method, and the like. In addition, the memory 620 may include a high-speed random access memory, or may also include a non-volatile memory such as at least one disk storage device, flash storage device, or another non-volatile solid-state storage device. In some embodiments, the memory 620 optionally includes memories that are remotely disposed with respect to the processor 610, and the remote memories may be connected, via a network, to the user interface control layout system. Examples of the foregoing network include but are not limited to: the Internet, an intranet, a local area network, a mobile communications network, or a combination thereof.

The one or more modules are stored in the memory 620; when the one or more modules are executed by the one or more processors 610, the user interface control controlling method in any one of the foregoing method embodiments is executed.

The foregoing product can execute the method provided in the embodiments of this disclosure, and has corresponding functional modules for executing the method and beneficial effects. Refer to the method provided in the embodiments of this disclosure for technical details that are not described in detail in this embodiment.

The electronic device in this embodiment of this disclosure exists in multiple forms, including but not limited to:

(1) Mobile communication device: such devices are characterized by having a mobile communication function, and primarily providing voice and data communications; terminals of this type include: a smart phone (for example, an iPhone), a multimedia mobile phone, a feature phone, a low-end mobile phone, and the like;

(2) Ultra mobile personal computer device: such devices are essentially personal computers, which have computing and processing functions, and generally have the function of mobile Internet access; terminals of this type include: PDA, MID and UMPC devices, and the like, for example, an iPad;

(3) Portable entertainment device: such devices can display and play multimedia content; devices of this type include: an audio and video player (for example, an iPod), a handheld game console, an e-book, an intelligent toy and a portable vehicle-mounted navigation device;

(4) Server: a device that provides a computing service; a server includes a processor, a hard disk, a memory, a system bus, and the like; an architecture of a server is similar to a universal computer architecture. However, because a server needs to provide highly reliable services, requirements for the server are high in aspects of the processing capability, stability, reliability, security, extensibility, and manageability; and

(5) Other electronic apparatuses having a data interaction function.

The apparatus embodiment described above is merely exemplary, and units described as separated components may be or may not be physically separated; components presented as units may be or may not be physical units, that is, the components may be located in a same place, or may be also distributed on multiple network units. Some or all modules therein may be selected according to an actual requirement to achieve the objective of the solution of this embodiment.

Through description of the foregoing implementation manners, a person skilled in the art can clearly learn that each implementation manner can be implemented by means of software in combination with a universal hardware platform, and certainly, can be also implemented by using hardware. Based on such understanding, the essence, or in other words, a part that makes contributions to relevant technologies, of the foregoing technical solutions can be embodied in the form of a software product. The computer software product may be stored in a computer readable storage medium, for example, a ROM/RAM, a magnetic disk, or a compact disc, including several instructions for enabling a computer device (which may be a personal computer, a sever, or a network device, and the like) to execute the method in the embodiments or in some parts of the embodiments.

Finally, it should be noted that: the foregoing embodiments are only used to describe the technical solutions of this disclosure, rather than limit this disclosure. Although this disclosure is described in detail with reference to the foregoing embodiments, a person of ordinary skill in the art should understand that he/she can still modify technical solutions disclosed in the foregoing embodiments, or make equivalent replacements to some technical features therein; however, the modifications or replacements do not make the essence of corresponding technical solutions depart from the spirit and scope of the technical solutions of the embodiments of this disclosure.

1. A user interface control layout method, applied to an electronic device, comprising the following steps:
creating a relative layout container, wherein the relative layout container is used to contain child controls, and the child controls are a relative layout container or a normal control;
specifying an attribute of a child control for the relative layout container;
generating the child control; and
if the child control is a relative layout container, repeating the foregoing steps, until all the child controls in the relative layout container are normal controls.

2. The user interface control layout method according to claim 1, wherein the step of specifying an attribute of a child control for the relative layout container comprises the following sub-steps:
specifying a type of the child control for the relative layout container, and automatically numbering the child control;
specifying a position reference control for the child control;
setting a position offset of the child control relative to the reference control; and
setting a size of the child control.

3. The user interface control layout method according to claim 2, wherein in the step of specifying a position reference control for the child control,
if the child control is a first child control in the relative layout container, the relative layout container is specified as the reference control; and
in the step of setting a position offset of the child control relative to the reference control,
the position offset is a first preset offset distance relative to a position of the reference control.

4. The user interface control layout method according to claim 2, wherein in the step of specifying a position reference control for the child control,
if the child control is not a first child control in the relative layout container, another child control in a same relative layout container is specified as the child control as the reference control; and
in the step of setting a position offset of the child control relative to the reference control,
the position offset is a second preset offset distance relative to each edge of the reference control that is relatively close to the child control.

5. The user interface control layout method according to claim 1, wherein after the step of creating a relative layout container, and before the step of specifying an attribute of a child control for the relative layout container, the method further comprises the following steps:
creating a menu object in a scenario; and
binding the menu object to the relative layout container, and setting a position of the relative layout container in the scenario.

6. The user interface control layout method according to claim 1, wherein the child controls contained in the relative layout container are multiple user interface controls of different types and/or sizes; and
the normal control comprises any one of the following:
a regular layout container, a button control, a text control, or a picture control.

7-11. (canceled)

12. A non-volatile computer storage medium, which stores computer executable instructions that, when executed by an electronic device, cause the electronic device to:
create a relative layout container, wherein the relative layout container is used to contain child controls, and the child controls are a relative layout container or a normal control;
specify an attribute of a child control for the relative layout container;
generate the child control; and
if the child control is a relative layout container, repeat the foregoing steps, until all the child controls in the relative layout container are normal controls.

13. The non-volatile computer storage medium according to claim 12, wherein the electronic device is further caused to:
the step of specifying an attribute of a child control for the relative layout container cause the electronic device to:
specify a type of the child control for the relative layout container, and automatically numbering the child control;
specify a position reference control for the child control;
set a position offset of the child control relative to the reference control; and
set a size of the child control.

14. The non-volatile computer storage medium according to claim 13, wherein the electronic device is further caused to:
in the step of specifying a position reference control for the child control,
if the child control is a first child control in the relative layout container, the relative layout container is specified as the reference control; and
in the step of setting a position offset of the child control relative to the reference control,
the position offset is a first preset offset distance relative to a position of the reference control.

15. The non-volatile computer storage medium according to claim 13, wherein the electronic device is further caused to:
in the step of specifying a position reference control for the child control,
if the child control is not a first child control in the relative layout container, another child control in a same relative layout container is specified as the child control as the reference control; and
in the step of setting a position offset of the child control relative to the reference control,
the position offset is a second preset offset distance relative to each edge of the reference control that is relatively close to the child control.

16. The non-volatile computer storage medium according to claim 12, wherein after the step of creating a relative layout container, and before the step of specifying an attribute of a child control for the relative layout container, the electronic device is caused to:
create a menu object in a scenario; and
bind the menu object to the relative layout container, and set a position of the relative layout container in the scenario.

17. The non-volatile computer storage medium according to claim 12, wherein
the child controls contained in the relative layout container are multiple user interface controls of different types and/or sizes; and
the normal control comprises any one of the following:
a regular layout container, a button control, a text control, or a picture control.

18. An electronic device, comprising:
at least one processor; and
a memory communicably communication with the at least one processor, wherein the memory stores instructions executable by the at least one processor, wherein execution of the instructions by the at least one processor causes the at least one processor to:
create a relative layout container, wherein the relative layout container is used to contain child controls, and the child controls are a relative layout container or a normal control;
specify an attribute of a child control for the relative layout container;
generate the child control; and
if the child control is a relative layout container, repeat the foregoing steps, until all the child controls in the relative layout container are normal controls.

19. The electronic device according to claim 18, wherein the execution of the instructions to specifying an attribute of a child control for the relative layout container causes the at least one processor to:
specify a type of the child control for the relative layout container, and automatically numbering the child control;
specify a position reference control for the child control;
set a position offset of the child control relative to the reference control; and
set a size of the child control.

20. The electronic device according to claim 19, wherein in the step of specifying a position reference control for the child control, if the child control is a first child control in the relative layout container, the relative layout container is specified as the reference control; and
wherein in the step of setting a position offset of the child control relative to the reference control, the position offset is a first preset offset distance relative to a position of the reference control.

21. The electronic device according to claim 19, wherein in the step of specifying a position reference control for the child control, if the child control is not a first child control in the relative layout container, another child control in a same relative layout container is specified as the child control as the reference control; and
wherein in the step of setting a position offset of the child control relative to the reference control, the position offset is a second preset offset distance relative to each edge of the reference control that is relatively close to the child control.

22. The electronic device according to claim 18, wherein after the execution of the instructions to create a relative layout container, and before the step of specifying an attribute of a child control for the relative layout container, the at least one processor is caused to:
create a menu object in a scenario; and
bind the menu object to the relative layout container, and setting a position of the relative layout container in the scenario.

23. The electronic device according to claim 18, wherein
the child controls contained in the relative layout container are multiple user interface controls of different types and/or sizes; and
the normal control comprises any one of the following:
a regular layout container, a button control, a text control, or a picture control.
